(19) United States
(12) Patent Application Publication
(10) Pub. No.: US 2015/0124091 A1
(43) Pub. Date: May 7, 2015

(54) DOOR VIEWING SYSTEM AND APPARATUS

(71) Applicant: Mark Stahl, Lewisville, TX (US)

(72) Inventor: Mark Stahl, Lewisville, TX (US)

(21) Appl. No.: 14/528,534

(22) Filed: Oct. 30, 2014

Related U.S. Application Data
(60) Provisional application No. 61/900,172, filed on Nov. 5, 2013.

(51) Int. Cl. H04N 7/18; H04N 5/232

(52) U.S. Cl. CPC H04N 7/183; H04N 5/23216
USPC 348/143

(57) ABSTRACT

A liquid crystal display door viewing apparatus. The door viewing apparatus includes a display panel (e.g., Liquid crystal display) that can be configured to align with an existing peephole lens coupled to a door of varying thickness. The display panel includes a viewing screen to view a clear non-distorted image (color or black and white) of various objects located on the other side of the door from any height and viewing angle. A touch button located in association with the display panel can be pressed to display the image on the display panel for easy and safe operation. The door viewer apparatus can also be removed and a peephole reviewer can be re-installed.

### CROSS-REFERENCE TO PROVISIONAL APPLICATION

This application clams priority under 35 U.S.C. 119(e) to U.S. Provisional Patent Application Ser. No. 61/900,172, which was filed on Nov. 5, 2013, the disclosure of which is incorporated herein by reference in its entirety.

### FIELD OF THE INVENTION

Embodiments are generally related to security devices, systems, and methods thereof. Embodiments are also related to peepholes and door viewer devices.

### BACKGROUND

Security systems are employed in a variety of situations to detect intrusion or unauthorized entry. For example, such systems and related devices and components are implemented in residential, commercial, industrial, and military settings for protection against theft (e.g., burglary), property damage, as well as personal protection against intruders. Conventionally, the so-called “peephole” is installed on one side of a door to observe people on other side of the door without opening the door. Thus, such a device is typically provided as a small hole in a door that may be looked through in order to identify visitors before the door is opened.

Glass peepholes are generally fitted with a fisheye lens to permit a wider field of view from inside a door, for example, and offer little to no visibility from the outside. Such prior art security devices provide poor image quality in low light and the image may not be easy to identify. Also, viewing through a peephole may be difficult for users whose height is not within a particular range or who have difficulty with their eyesight. Additionally, such a “fisheye” peephole lens is expensive, cumbersome, and difficult to install. A professional security provider usually performs installation and maintenance of such devices.

Based on the foregoing, it is believed that a need exists for an improved door viewing apparatus, as will be described in greater detail herein.

### SUMMARY

The following summary is provided to facilitate an understanding of some of the innovative features unique to the disclosed embodiments and is not intended to be a full description. A full appreciation of the various aspects of the embodiments disclosed herein can be gained by taking the entire specification, claims, drawings, and abstract as a whole.

It is, therefore, one aspect of the disclosed embodiments to provide for improved security devices, systems, and methods.

It is another aspect of the disclosed embodiments to provide for an LCD (Liquid Crystal Display) door viewing apparatus.

The aforementioned aspects and other objectives and advantages can now be achieved as described herein. A liquid crystal display door viewing apparatus is disclosed herein. The door viewing apparatus can include a display panel (e.g., LCD) configured to align with an existing peephole lens that is coupled to a door of varying thickness. The display panel includes a viewing screen to view a clear non-distorted image (e.g., color or black and white) of various objects located on the other side of the door from any height and viewing angle. A touch button can be located in association with the display panel and can be pressed to display the image on the display panel for easy and safe operation. The door viewer apparatus can also be removed and a peephole reviewer can be re-installed.

A base flange and a peephole barrel can connect the peephole lens to the display panel. The apparatus includes an image capturing unit to capture the image of the objects (e.g., doorstep, deliveries, mailman, vandals/thieves, etc.) on the other side of the door and for night viewing. The image capturing unit can be, for example, an infrared image capturing unit and/or a motion-activated image capturing unit. The apparatus further includes a door bell and provides a two-way communication with respect to the door. The size of the viewing screen associated with the display panel can be varied based upon design consideration.

A remote receiver and a mobile communication device can be wirelessly connected to the apparatus via a wireless transmitting circuit to transmit and receive the image of objects on the other side of the door. The image capturing unit further includes an image processing unit to process and store the image of the objects on a storage recorder. The apparatus is inexpensive and easily operated, provides a clear image, and can be viewed by the user of any height.

### BRIEF DESCRIPTION OF THE FIGURES

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a block diagram of an LCD door viewing system, In accordance with the disclosed embodiments:

FIG. 2 illustrates a perspective view of an LCD door viewing apparatus coupled to a door via an existing peephole lens, in accordance with the disclosed embodiments;

FIGS. 3-4 illustrate a front view of the LCD door viewing apparatus and a peephole lens, in accordance with an alternative embodiment; and

FIGS. 5-6 illustrate a front view of the LCD door viewing apparatus and a peephole lens having an infrared image capturing unit and a doorbell, in accordance with an alternative embodiment.

### DETAILED DESCRIPTION

The particular values and configurations discussed in these non-limiting examples can be varied and are cited merely to illustrate at least one embodiment and are not intended to limit the scope thereof.

The embodiments will now be described more fully hereinafter with reference to the accompanying drawings, in which illustrative embodiments of the invention are shown. The embodiments disclosed herein can be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout. As used herein, the term “and/or” includes any and all combinations of one or more of the associated listed items.

The terminology used herein is for the purpose of describing particular embodiments only and is not intended to be limiting of the invention. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

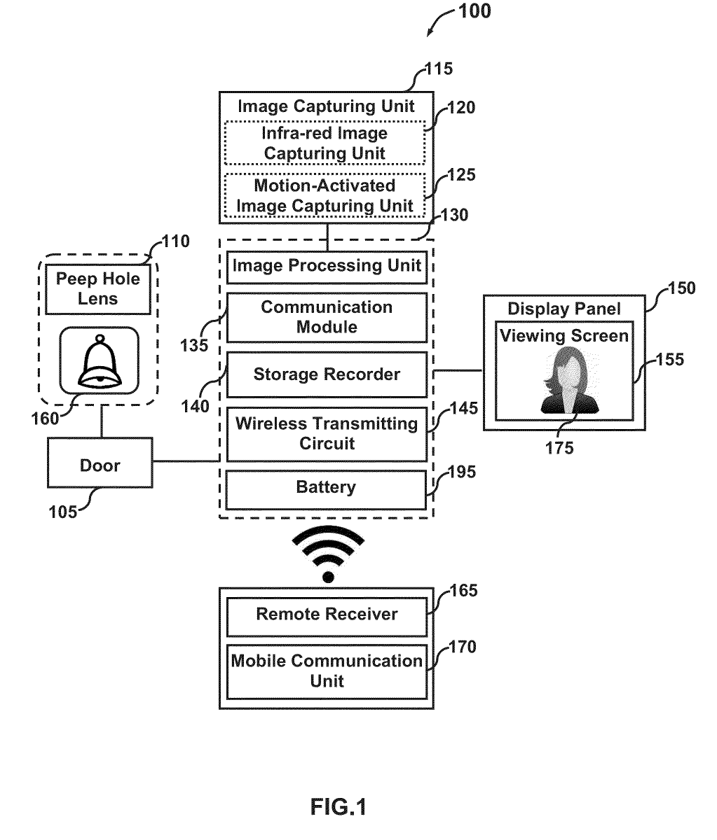

FIG. 1 illustrates a block diagram of an LCD door viewing system 100, in accordance with the disclosed embodiments. The door viewing system 100 includes a display panel 150 that can be configured to align with an existing peephole lens 110 coupled to a door 105 with varying thickness. Note that the display panel 150 can be, for example, an LCD, depending upon design consideration. The LCD is a flat panel display, electronic visual display, or video display that uses the light modulating properties of liquid crystals. Although LCD is a preferred mode of display, it can be appreciated that other types of displays may also be implemented and that the disclosed embodiments are not limited to LCDs.

The display panel 150 can further include a viewing screen 155 to view a clear non-distorted image 175 of an object located on the other side of the door 105 from any height and viewing angle. Note that the non-distorted image 175 can be displayed as a color or black and white image. The door viewer system 100 can also be removed and a traditional peephole reviewer can be re-installed. The size of the viewing screen 155 can be varied, based on design consideration.

The system 100 includes an image-capturing unit 115 to capture the image 175 on the other side of the door 105 and for night viewing. The image capturing unit 115 can be, for example, an infrared image capturing unit 120 and/or a motion-activated image capturing unit 125. The image capturing unit 115 captures outside images via the peephole lens 110 for processing by an image processing unit 130, enabling the processed signal to be further displayed via the viewing screen 155.

A communications module 135 can be employed to transmit digital image signals from the image-processing unit 130 to the viewing screen 155. The processed image indicative of the objects (e.g., doorstep, deliveries, mailman, vandals/thieves, etc.) can be stored in, for example, a storage recorder 140 or another appropriate electronic storage medium. The apparatus or system 100 can also house a battery 195 to provide the necessary working voltage. The apparatus 100 further includes a door bell 160 and provides a two-way communication with respect to the door 105. A remote receiver 165 and a mobile communication device 170 (e.g., smartphone, tablet computing device, etc.) can be wirelessly connected to the apparatus 100 via a wireless transmitting circuit 145 to transmit and receive image of various objects located on the other side of the door 105.

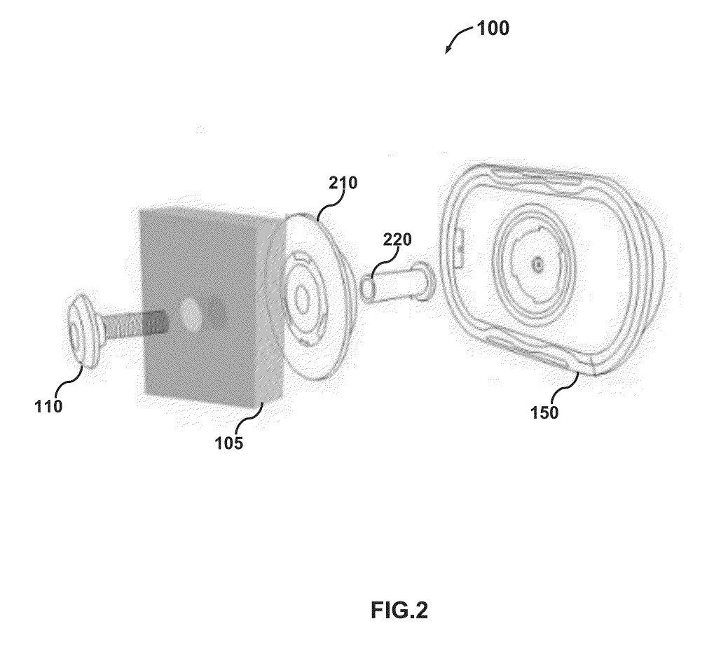

FIG. 2 illustrates a perspective view of the LCD door viewing system 100 depicted in FIG. 1 and coupled to a door 105 via an existing peephole lens 110, in accordance with the disclosed embodiments. Note that in FIGS. 1-6, identical or similar blocks are generally indicated by identical reference numerals. As shown in FIG. 2, a base flange 210 and a peephole barrel 220 can connect the peephole lens 110 to the display panel 150.

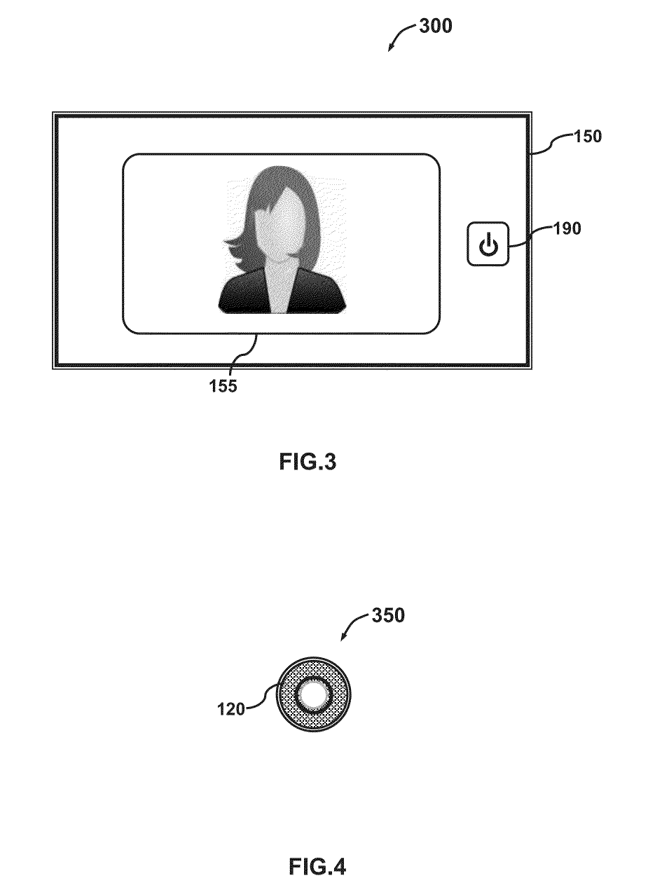

FIGS. 3-4 illustrate a front view of an LCD door viewing apparatus 300 and a peephole lens 350, in accordance with an alternative embodiment. A touch button 190 can be pressed to display the image 175 on the display panel 150 for easy and safe operation. The size of the viewing screen 155 can be varied from, for example, 2.25″-7″.

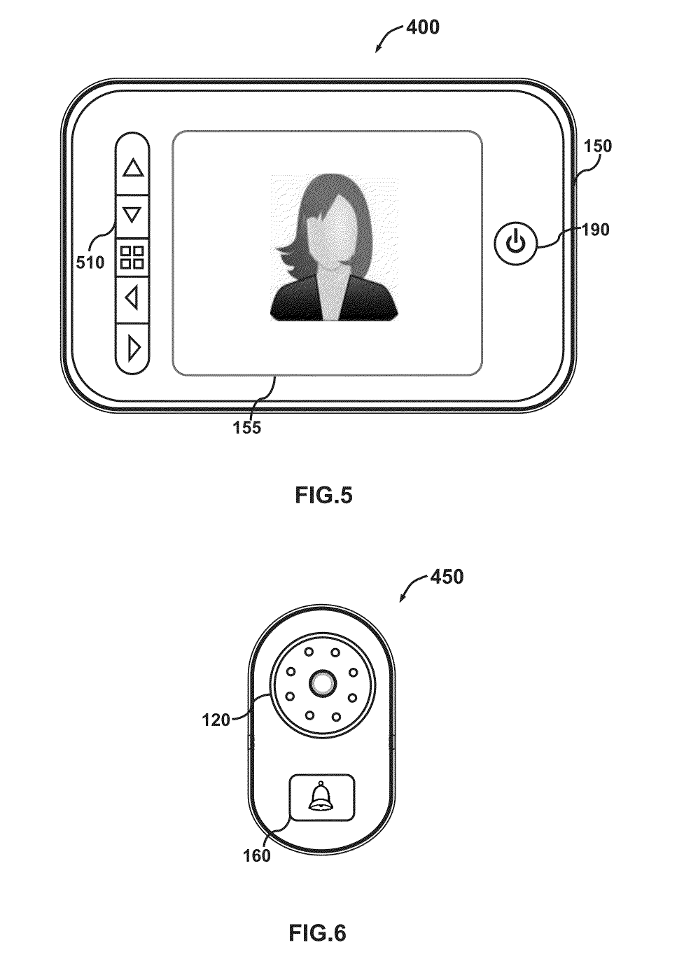

FIGS. 5-6 illustrate a front view of an LCD door viewing apparatus 400 that includes a peephole lens 450 in association with the infrared image capturing unit 120 and the doorbell 160 shown in FIG. 1, in accordance with an alternative embodiment. Note that as indicated previously, identical reference numerals utilized herein refer generally to the same or similar component, although individual figures may illustrate alternative embodiments. The infrared image capturing unit 120 associated with the system 100 depicted in FIG. 1 can be employed for night vision so that the resulting scene, which is apparently dark to a human observer, appears as a monochrome image on the display panel 150 also shown in FIG. 5.

The infrared image capturing unit 120 can be a configured device that forms an image utilizing infrared radiation, similar to, for example, a common camera that forms an image using visible light. Instead of the 450-750 nanometer range of the visible light camera, for example, infrared cameras can operate in wavelengths as long as 14,000 nm (14 μm). The apparatus 400 depicted in FIG. 5 includes a plurality of buttons 510 to display the stored image on the display panel 150. Note the door viewing devices/systems 100, 300, and 400 described herein are inexpensive to configure and easily operated while providing a clear image of an object and can be accessed by a user of any height.

Note that in some embodiments, the existing peephole lens may be utilized. However, in a preferred embodiment, a camera lens that looks like a traditional peephole lens can be employed, which is wired to the viewing display. From the outside of the door, it appears like a traditional peep hole lens, when in fact it is a camera lens.

Based on the foregoing, it can be appreciated that a number of embodiments are disclosed, preferred and alternative, For example, in a preferred embodiment, a door viewer apparatus can be disclosed, which includes a display panel configured to align with an existing peephole lens that is coupled to a door of varying thickness; a viewing screen associated with the display panel displays a non-distorted image of at least one object located on the other side of the door from any height and viewing angle; and a touch button located in association with the display panel is pressed to display the image on the display panel for easy and safe operation wherein the apparatus is removed and a peephole reviewer is re-installed.

In some embodiments, the display panel comprises a liquid crystal display panel. In other embodiments, a camera lens can be located within or replaces the existing peephole lens and communicates electronically with the display panel to display the image captured by the camera lens. In yet other embodiments, the viewing screen displays a color image. In still other embodiments, the viewing screen can display a black and white image,

In another embodiment, an infrared image capturing unit can be provided, which forms an image utilizing infrared radiation for display of the image via the viewing screen associated with the display panel. In some embodiments, the infrared capturing unit can be configured for night vision and display of the image as a monochrome image on the viewing screen associated with the display panel.

In still another embodiment, a door viewer method can be implemented, which includes, for example, the steps or operations of configuring a display panel to align with an existing peephole lens that is coupled to a door of varying thickness; associating a viewing screen with the display panel to display a non-distorted image of at least one object located on the other side of the door from any height and viewing angle; and locating a touch button in association with the display panel, wherein the touch button is pressed to display the image on the display panel for easy and safe operation wherein the apparatus is removed and a peephole reviewer is re-installed.

It will be appreciated that variations of the above-disclosed and other features and functions, or alternatives thereof, may be desirably combined into many other different systems or applications. Also, that various presently unforeseen or unanticipated alternatives, modifications, variations or improvements therein may be subsequently made by those skilled in the art which are also intended to be encompassed by the following claims.

What is claimed is:

1. A door viewer apparatus, comprising;
a display panel configured to align with an existing peephole lens that is coupled to a door of varying thickness;
a viewing screen associated with said display panel displays a non-distorted image of at least one object located on the other side of said door from any height and viewing angle; and
a touch button located in association with said display panel is pressed to display said image on said display panel for easy and safe operation wherein said apparatus is removed and a peephole reviewer is re-installed.

2. The apparatus of claim 1 wherein said display panel comprises a liquid crystal display panel.

3. The apparatus of claim 1 wherein a camera lens is located within or replaces said existing peephole lens and communicates electronically with said display panel to display said image captured by said camera lens.

4. The apparatus of claim 1 wherein said viewing screen displays a color image.

5. The apparatus of claim 1 wherein said viewing screen displays a black and white mage.

6. The apparatus of claim 1 further comprising an infrared image capturing unit that forms an image utilizing infrared radiation for display of said image via said viewing screen associated with said display panel.

7. The apparatus of claim 6 wherein said infrared capturing unit is configured for night vision and display of said image as a monochrome image on said viewing screen associated with said display panel.

8. The apparatus of claim 1 wherein said display panel comprises a liquid crystal display panel and wherein a camera lens is located within or replaces said existing peephole lens and communicates electronically with said display panel to display said image captured by said camera lens.

9. The apparatus of claim 8 further comprising an infrared image capturing unit that forms an image utilizing infrared radiation for display of said image via said viewing screen associated with said display panel.

10. The apparatus of claim 9 wherein said infrared capturing unit is configured for night vision and display of said image as a monochrome image on said viewing screen associated with said display panel.

11. A door viewer system, comprising:
a display panel configured to align with an existing peephole lens that is coupled to a door of varying thickness, wherein said display panel comprises a liquid crystal display panel;
a viewing screen associated with said display panel displays a non-distorted image of at least one object located on the other side of said door from any height and viewing angle;
a touch button located in association with said display panel is pressed to display said image on said display panel for easy and safe operation wherein said apparatus is removed and a peephole reviewer is re-installed; and
an infrared image capturing unit that forms an image utilizing infrared radiation for display of said image via said viewing screen associated with said display panel.

12. The apparatus of claim 11 wherein a camera lens is located within or replaces said existing peephole lens and communicates electronically with said display panel to display said image captured by said camera lens.

13. The apparatus of claim 11 wherein said viewing screen displays a color image,

14. The apparatus of claim 11 wherein said viewing screen displays a black and white image.

15. The apparatus of claim 11, wherein said infrared capturing unit is configured for night vision and display of said image as a monochrome image on said viewing screen associated with said display panel.

16. A door viewer method, comprising:
configuring a display panel to align with an existing peephole lens that is coupled to a door of varying thickness;
associating a viewing screen with said display panel to display a non-distorted image of at least one object located on the other side of said door from any height and viewing angle.; and
locating a touch button in association with said display panel, wherein said touch button is pressed to display said image on said display panel for easy and safe operation wherein said apparatus is removed and a peephole reviewer is re-installed.

17. The method of claim 16 wherein said display panel comprises a liquid crystal display panel.

18. The method of claim 16 wherein a camera lens is located within or replaces said existing peephole lens and communicates electronically with said display panel to display said image captured by said camera lens.

19. The method of claim 16 wherein said viewing screen displays a color image and/or a black and white image.

20. The method of claim 16 further comprising providing an infrared image capturing unit that forms an image utilizing infrared radiation for display of said image via said viewing screen associated with said display panel.
